(19) United States
(12) Patent Application Publication
(10) Pub. No.: US 2026/0213441 A1
(43) Pub. Date: Jul. 23, 2026

(54) FIXING STRUCTURE, SUBSTRATE UNIT, AND FLEXIBLE SUBSTRATE UNIT

(71) Applicant: Japan Aviation Electronics Industry, Ltd., Tokyo (JP)

(72) Inventors: Yukitaka TANAKA, Tokyo (JP); Kentaro TODA, Tokyo (JP)

(21) Appl. No.: 19/421,199

(22) Filed: Dec. 16, 2025

(30) Foreign Application Priority Data
Jan. 20, 2025 (JP) 2025-007841

(51) Int. Cl. H01R 12/73; H01R 12/70; H01R 13/405; H01R 13/436; H01R 13/44; H01R 13/627

(52) U.S. Cl. CPC H01R 12/73; H01R 12/7023; H01R 13/405; H01R 13/4361; H01R 13/44; H01R 13/6272

(57) ABSTRACT

A fixing structure capable of fixing a position of a flexible substrate relative to a connection substrate with a simple configuration in an insertion direction of the flexible substrate into a cage is provided. A fixing structure according to one aspect of the present disclosure includes: a housing fixed to a flexible substrate; a lock claw fixed to the housing; a cage fixed to a connection substrate, the housing being capable of being inserted and removed into and from the cage in a direction parallel to a surface on which contact points of the connection substrate are disposed; a lock hole which is formed in the cage and with which the lock claw is engaged; and a pushing part that is fixed to the housing or the cage and pushes the housing toward the connection substrate.

### INCORPORATION BY REFERENCE

This application is based upon and claims the benefit of priority from Japanese patent application No. 2025-7841, filed on Jan. 20, 2025, the disclosure of which is incorporated herein in its entirety by reference.

### BACKGROUND

The present disclosure relates to a fixing structure, a substrate unit, and a flexible substrate unit.

For example, as shown in FIG. 39, a connector 101 disclosed in Patent Literature 1 is configured to insert, in a state in which a concave part 102a formed in a side part of a flexible substrate 102 is engaged with a retaining piece 103a and a pressing piece 103b of a slider 103, the flexible substrate 102 into a plate wire insertion part of a housing fixed to a connection substrate along with the slider 103 and insert a pressure plate part of the slider 103 between the flexible substrate 102 and a contact, thereby pushing the flexible substrate 102 toward the contact and connecting them.

[Patent Literature 1] Japanese Unexamined Patent Application Publication No. 2005-5136

### SUMMARY

In the connector 101 disclosed in Patent Literature 1, the slider 103 is required to be disposed to fix the position of the flexible substrate 102 with respect to the connection substrate in an insertion direction of the flexible substrate 102 into the housing, which raises a problem that the configuration is complicated.

An object of the present disclosure is to provide a fixing structure, a substrate unit, and a flexible substrate unit capable of fixing the position of a flexible substrate with respect to a connection substrate with a simple configuration in an insertion direction of the flexible substrate into a cage.

A fixing structure according to one aspect of the present disclosure is a fixing structure of a flexible substrate and a connection substrate, the fixing structure including: a housing that is fixed to the flexible substrate in such a way that contact points of the flexible substrate are exposed; a lock claw fixed to the housing; a cage that is fixed to the connection substrate so as to cover contact points of the connection substrate, the housing being capable of being inserted and removed into and from the cage in a direction parallel to a surface on which the contact points of the connection substrate are disposed; a lock hole which is formed in the cage and with which the lock claw is engaged in a state in which the housing is inserted into the cage; and a pushing part that is fixed to the housing or the cage and pushes the housing toward the connection substrate in the state in which the housing is inserted into the cage.

A substrate unit according to one aspect of the present disclosure includes: the aforementioned fixing structure; a flexible substrate to which the housing of the fixing structure is fixed; and a connection substrate to which the cage of the fixing structure is fixed, in which a plurality of rows of contact points of the connection substrate are disposed in such a way that they are spaced apart from each other in an insertion and removal direction of the housing into and from the cage, and the contact points of the connection substrate are disposed in such a way that they do not overlap each other in a direction perpendicular to the insertion and removal direction of the housing into and from the cage and a thickness direction of the connection substrate as seen from the insertion and removal direction of the housing into and from the cage.

A flexible substrate unit according to one aspect of the present disclosure is a flexible substrate unit used in the aforementioned substrate unit, the flexible substrate unit including: the flexible substrate; a housing that is fixed to the flexible substrate in such a way that contact points of the flexible substrate are exposed, the housing being capable of being inserted and removed into and from the cage fixed to a connection substrate in a direction parallel to a surface on which contact points of the connection substrate are disposed; a lock claw that is fixed in the housing and is capable of engaging with a lock hole formed in the cage; and a contacting part that a pushing part that is fixed to the housing to push the housing toward the connection substrate in a state in which the housing is inserted into the cage or a pushing part that is fixed to the cage to push the housing toward the connection substrate in the state in which the housing is inserted into the cage contacts, the contacting part being fixed to the housing.

According to the present disclosure, it is possible to provide a fixing structure, a substrate unit, and a flexible substrate unit capable of fixing the position of a flexible substrate with respect to a connection substrate with a simple configuration in an insertion direction of the flexible substrate into a cage.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a state in which a flexible substrate unit is fixed to a connection substrate in a substrate unit according to the first embodiment as seen from a positive side of a Z-axis;

FIG. 2 is a perspective view showing a state before a housing of the flexible substrate unit is inserted into a cage fixed to the connection substrate in the substrate unit according to the first embodiment as seen from the positive side of the Z-axis;

FIG. 3 is a YZ cross-sectional view of the substrate unit shown in FIG. 1;

FIG. 4 is an exploded perspective view of the substrate unit according to the first embodiment as seen from the positive side of the Z-axis;

FIG. 5 is a perspective view showing the flexible substrate of the substrate unit according to the first embodiment as seen from a negative side of the Z-axis;

FIG. 6 is a perspective view showing the cage of a fixing structure in the substrate unit according to the first embodiment as seen from the positive side of the Z-axis;

FIG. 7 is another perspective view showing the cage of the fixing structure in the substrate unit according to the embodiment as seen from the positive side of the Z-axis;

FIG. 8 is a perspective view showing a flexible substrate unit of the substrate unit according to the first embodiment as seen from the positive side of the Z-axis;

FIG. 9 is another perspective view showing the flexible substrate unit of the substrate unit according to the first embodiment as seen from the positive side of the Z-axis;

FIG. 10 is a diagram showing the flexible substrate unit of the substrate unit according to the first embodiment as seen from the positive side of the Z-axis;

FIG. 11 is a perspective view showing the flexible substrate unit of the substrate unit according to the first embodiment as seen from the negative side of the Z-axis;

FIG. 12 is a perspective view showing an elastic deformation part of the fixing structure in the substrate unit according to the first embodiment as seen from the positive side of the Z-axis;

FIG. 13 is another perspective view showing the elastic deformation part of the fixing structure in the substrate unit according to the first embodiment as seen from the positive side of the Z-axis;

FIG. 14 is a perspective view showing a first housing of the fixing structure in the substrate unit according to the first embodiment as seen from the positive side of the Z-axis;

FIG. 15 is another perspective view showing the first housing of the fixing structure in the substrate unit according to the first embodiment as seen from the positive side of the Z-axis;

FIG. 16 is a perspective view showing the flexible substrate and a second housing of the fixing structure in the substrate unit according to the first embodiment as seen from the positive side of the Z-axis;

FIG. 17 is a YZ cross-sectional view showing the flexible substrate and the second housing shown in FIG. 16;

FIG. 18 is a perspective view showing a state in which a flexible substrate unit is fixed to a connection substrate in a substrate unit according to a second embodiment as seen from the positive side of the Z-axis;

FIG. 19 is a perspective view showing a state before a housing of the flexible substrate unit is inserted into a cage fixed to the connection substrate in the substrate unit according to the second embodiment as seen from the positive side of the Z-axis;

FIG. 20 is a diagram showing the state in which the flexible substrate unit is fixed to the connection substrate in the substrate unit according to the second embodiment as seen from a positive side of an X-axis;

FIG. 21 is a YZ cross-sectional view of the substrate unit in FIG. 18;

FIG. 22 is an exploded perspective view showing the substrate unit according to the second embodiment as seen from the positive side of the Z-axis;

FIG. 23 is a perspective view showing a cage of a fixing structure in the substrate unit according to the second embodiment as seen from the positive side of the Z-axis;

FIG. 24 is another perspective view showing the cage of the fixing structure in the substrate unit according to the second embodiment as seen from the positive side of the Z-axis;

FIG. 25 is a perspective view showing the flexible substrate unit of the substrate unit according to the second embodiment as seen from the positive side of the Z-axis;

FIG. 26 is a perspective view showing the flexible substrate unit of the substrate unit according to the second embodiment as seen from the negative side of the Z-axis;

FIG. 27 is a YZ cross-sectional view of the flexible substrate unit shown in FIG. 25;

FIG. 28 is a perspective view showing a shell and an elastic deformation part of the fixing structure in the substrate unit according to the second embodiment as seen from the positive side of the Z-axis;

FIG. 29 is a perspective view showing the shell and the elastic deformation part of the fixing structure in the substrate unit according to the second embodiment as seen from the negative side of the Z-axis;

FIG. 30 is a perspective view showing the flexible substrate and the housing of the fixing structure in the substrate unit according to the second embodiment as seen from the positive side of the Z-axis;

FIG. 31 is a perspective view showing a state in which a lock claw of the flexible substrate unit is engaged with a lock hole of the cage in the substrate unit according to the second embodiment as seen from the positive side of the Z-axis;

FIG. 32 is a perspective view showing a state in which a flexible substrate unit is fixed to a connection substrate in a substrate unit according to a third embodiment as seen from a positive side of a Z-axis;

FIG. 33 is a perspective view showing a state before a housing of the flexible substrate unit is inserted into a cage fixed to the connection substrate in the substrate unit according to the third embodiment as seen from the positive side of the Z-axis;

FIG. 34 is a diagram showing the state in which the flexible substrate unit is fixed to the connection substrate in the substrate unit according to the third embodiment as seen from a positive side of an X-axis;

FIG. 35 is a YZ cross-sectional view of the substrate unit shown in FIG. 32;

FIG. 36 is an exploded perspective view showing the substrate unit according to the third embodiment as seen from the positive side of the Z-axis;

FIG. 37 is a perspective view showing the flexible substrate unit of the substrate unit according to the third embodiment as seen from the positive side of the Z-axis;

FIG. 38 is another perspective view showing the flexible substrate unit of the substrate unit according to the third embodiment as seen from the positive side of the Z-axis; and

FIG. 39 is a diagram showing FIG. 7(a) of Patent Literature 1.

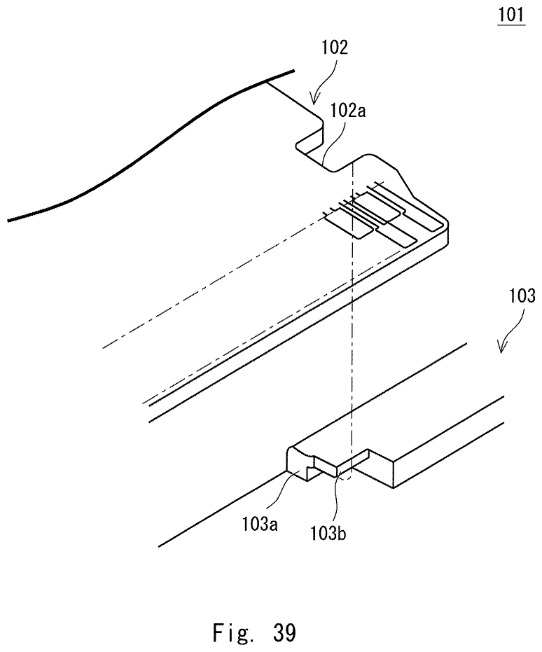

### DESCRIPTION OF EMBODIMENTS

Hereinafter, with reference to the drawings, specific embodiments to which the present disclosure is applied will be described in detail. Note that the present disclosure is not limited to the following embodiments. Further, for the sake of clarity of the description, the following descriptions and the drawings are simplified as appropriate. In the following description, a three-dimensional (XYZ) coordinate system is used to clarify the explanation.

### First Embodiment

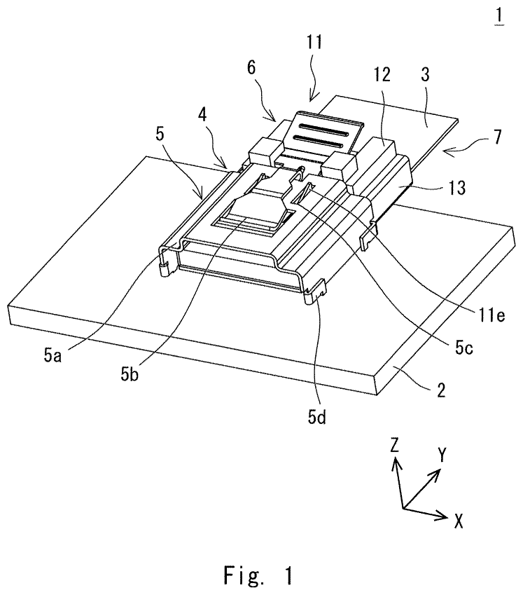

First, a configuration of a substrate unit according to this embodiment will be described. FIG. 1 is a perspective view showing a state in which a flexible substrate unit is fixed to a connection substrate in the substrate unit according to this embodiment as seen from a positive side of a Z-axis.

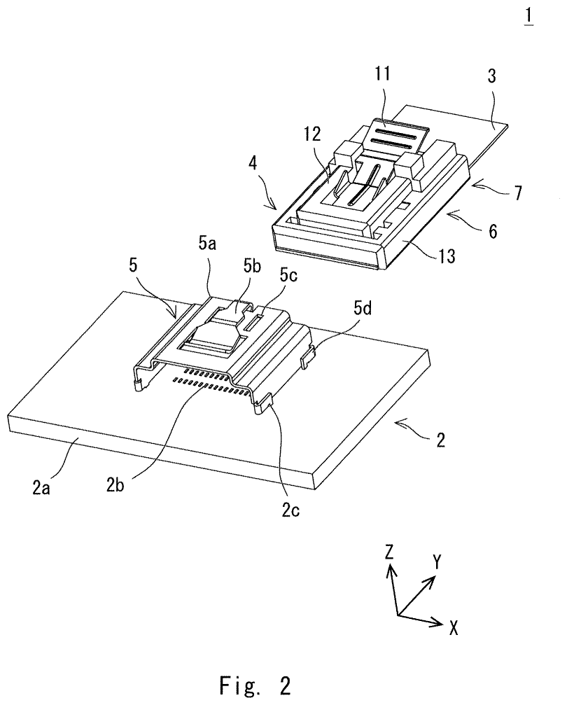

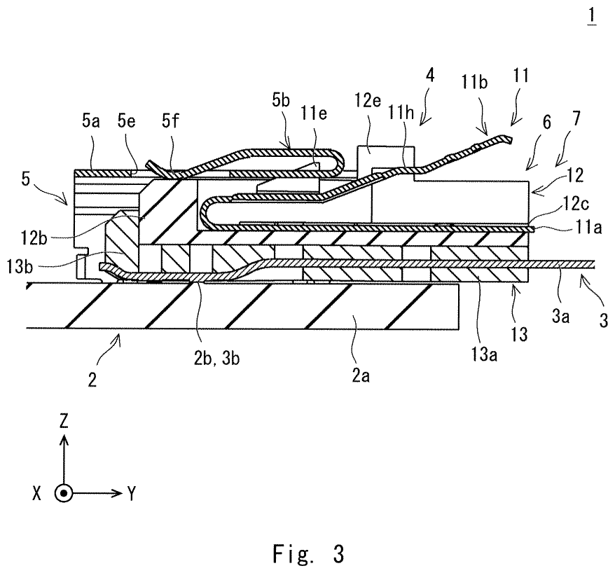

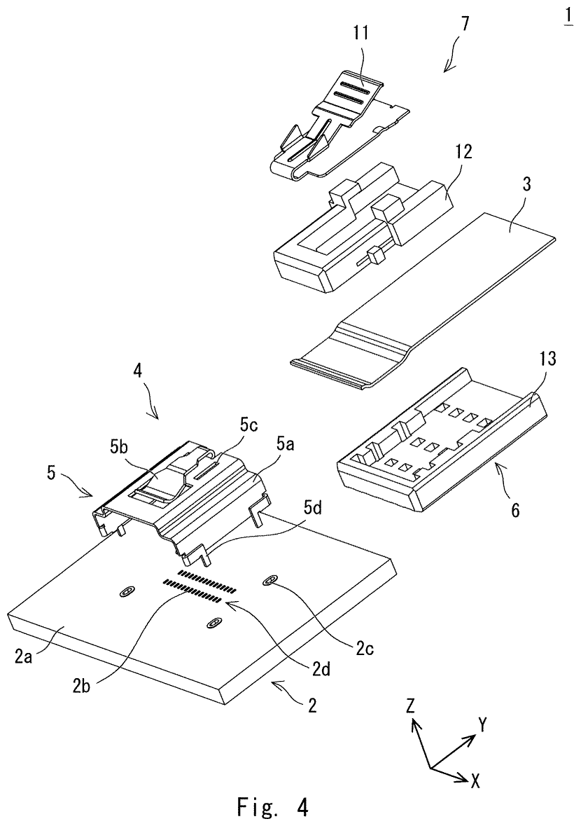

FIG. 2 is a perspective view showing a state before a housing of the flexible substrate unit is inserted into a cage fixed to the connection substrate in the substrate unit according to this embodiment as seen from the positive side of the Z-axis. FIG. 3 is a YZ cross-sectional view of the substrate unit shown in FIG. 1. FIG. 4 is an exploded perspective view showing the substrate unit according to this embodiment as seen from the positive side of the Z-axis.

As shown in FIGS. 1 to 4, for example, a substrate unit 1 includes a connection substrate 2, a flexible substrate 3, and a fixing structure 4. The connection substrate 2 may be, for example, a main board on which a Central Processing Unit (CPU) and the like are mounted. The connection substrate 2 includes a main body 2a, contact points 2b, and penetrating holes 2c.

The main body 2a, which is, for example, a base material made of Flame Retardant Type 4(FR4) or the like, has a plate shape that is substantially parallel to the XY-plane. As shown in FIGS. 2 and 4, for example, the contact points 2b, which are contacting pads, are disposed on a surface on the positive side of the Z-axis of the main body 2a.

As shown in FIGS. 2 and 4, for example, the contact points 2b are disposed in the X-axis direction and the Y-axis direction in such a way that they are spaced apart from each other. That is, a plurality of contact points 2b disposed in the X-axis direction in such a way that they are spaced apart from each other form a contact point group 2d, and the contact point groups 2d are disposed in the Y-axis direction in such a way that they are spaced apart from each other.

At this time, as shown in FIG. 4, when a plurality of rows (e.g., two rows) of contact point groups 2d are disposed in the Y-axis direction, the contact points 2b of the contact point group 2d disposed on the positive side of the Y-axis and the contact points 2b of the contact point group 2d disposed on the negative side of the Y-axis may be disposed so as not to overlap each other, that is, disposed to be displaced from each other as seen from the Y-axis direction.

As shown in FIG. 4, the penetrating holes 2c penetrate through the main body 2a in the Z-axis direction. The penetrating holes 2c are disposed on the respective sides of the contact point groups 2d in the X-axis direction. Then, the penetrating holes 2c are disposed on the respective sides of the contact point groups 2d in the X-axis direction in such a way that they are spaced apart from each other in the Y-axis direction.

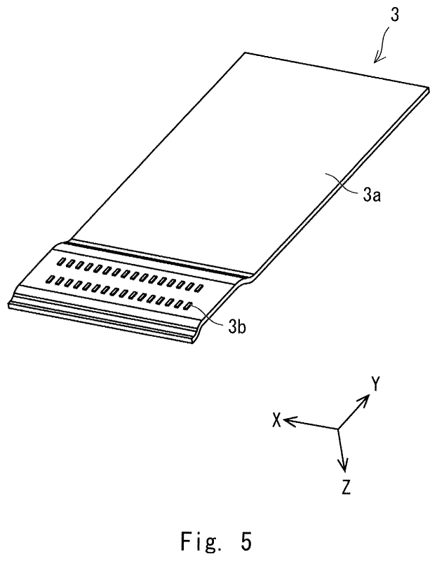

FIG. 5 is a perspective view showing the flexible substrate of the substrate unit according to this embodiment as seen from the negative side of the Z-axis. As shown in FIGS. 3 and 5, the flexible substrate 3 includes a main body 3a and contact points 3b.

The main body 3a is, for example, a base material made of a thin film such as polyimide, and has a plate shape that is substantially parallel to the XY-plane, as shown in FIGS. 3 and 5. The main body 3a has a substantially rectangular shape as seen from the Z-axis direction. Then, the part on the negative side of the Y-axis of the main body 3a has a substantially C-shape whose positive side of the Z-axis is opened as seen from the X-axis direction.

As shown in FIGS. 3 and 5, the contact points 3b, which are contacting pads, are disposed on the surface on the negative side of the Z-axis in the part on the negative side of the Y-axis of the flexible substrate 3. The contact points 3b are disposed so as to correspond to the contact points 2b of the connection substrate 2.

As shown in FIGS. 1 to 4, the fixing structure 4 includes a cage 5 and a housing unit 6. Here, the X-axis direction is a width direction of the substrate unit 1, the Y-axis direction is an insertion and removal direction of the housing unit 6 into and from the cage 5, and the Z-axis direction corresponds to a thickness direction of the substrate unit 1.

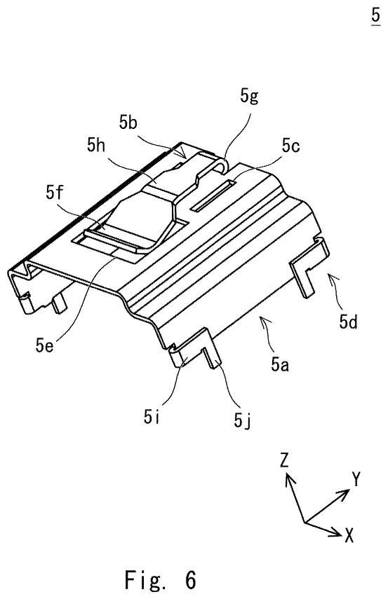

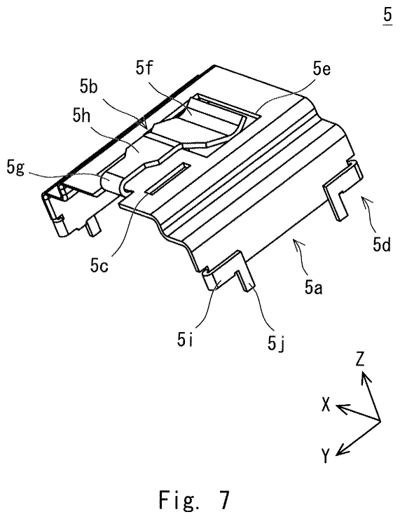

FIG. 6 is a perspective view showing the cage of the fixing structure in the substrate unit according to this embodiment as seen from the positive side of the Z-axis. FIG. 7 is another perspective view showing the cage of the fixing structure in the substrate unit according to this embodiment as seen from the positive side of the Z-axis.

The cage 5 is made of, for example, metal. As shown in FIGS. 6 and 7, the cage 5 includes a main body 5a, a pushing part 5b, lock holes 5c, and insertion parts 5d. The main body 5a has a semi-cylindrical shape whose negative side of the Z-axis is opened, and extends in the Y-axis direction.

As shown in FIGS. 6 and 7, for example, the main body 5a has a substantially rectangular shape as seen from the Y-axis direction, and the end part on the positive side of the Z-axis of the main body 5a may have a substantially hat shape. An opening part 5e that penetrates through the main body 5a in the Z-axis direction is formed in the end part on the positive side of the Z-axis of the main body 5a. The opening part 5e has, for example, a substantially rectangular shape as seen from the Z-axis direction.

As shown in FIGS. 6 and 7, the pushing part 5b is a plate spring that extends on the negative side of the Y-axis from the end part on the positive side of the Y-axis of the main body 5a so as to cover the main body 5a from the positive side of the Z-axis. The pushing part 5b is disposed at substantially the center of the main body 5a in the X-axis direction as seen from the Y-axis direction.

As shown in FIGS. 6 and 7, for example, the pushing part 5b includes a contacting part 5f, a folded part 5g, and a connection part 5h. The contacting part 5f has, for example, a substantially C-shape whose positive side of the Z-axis is opened as seen from the X-axis direction. The contacting part 5f has, for example, a substantially rectangular shape as seen from the Z-axis direction, and corner parts on the positive side of the Y-axis of the contacting part 5f may be chamfered.

As shown in FIGS. 6 and 7, the contacting part 5f is disposed so as to overlap the opening part 5e of the main body 5a as seen from the Z-axis direction, and covers the opening part 5e of the main body 5a from the positive side of the Z-axis. At this time, the end part on the negative side of the Z-axis of the contacting part 5f is protruded on the negative side of the Z-axis from the opening part 5e of the main body 5a.

As shown in FIGS. 6 and 7, for example, the folded part 5g has a substantially U-shape whose negative side of the Y-axis is opened as seen from the X-axis direction, and is protruded on the positive side of the Z-axis from the end part on the positive side of the Y-axis of the main body 5a. Then, the part of the folded part 5g that is protruded on the positive side of the Z-axis from the main body 5a extends on the negative side of the Y-axis. The folded part 5g has, for example, a substantially rectangular shape as seen from the Z-axis direction.

As shown in FIGS. 6 and 7, the connection part 5h connects the contacting part 5f to the folded part 5g. The connection part 5h has, for example, a substantially rectangular shape as seen from the Z-axis direction, and the corner parts on the negative side of the Y-axis of the connection part 5h may be chamfered.

As shown in FIGS. 6 and 7, the lock holes 5c are formed in end parts on the positive side of the Z-axis of the main body 5a. The lock holes 5c are disposed, for example, on the respective sides of the pushing part 5b in the X-axis direction as seen from the Z-axis direction on the positive side of the Y-axis with respect to the opening part 5e. The lock holes 5c have, for example, a substantially rectangular shape that is long in the Y-axis direction as seen from the Z-axis direction.

As shown in FIGS. 6 and 7, for example, the insertion parts 5d each include a folded part 5i and a claw part 5j. The folded part 5i has a substantially U-shape in which the inner side of the cage 5 is opened in the Y-axis direction as seen from the Z-axis direction, and is protruded on the outward of the cage 5 in the X-axis direction from the corner part on the negative side of the Z-axis of the main body 5a. The part of the folded part 5i that is protruded on the outward of the cage 5 extends toward the inner side of the cage 5 in the Y-axis direction.

As shown in FIGS. 6 and 7, the claw part 5j extends on the negative side of the Z-axis from the end part on the inner side of the cage 5 in the Y-axis direction in the folded part 5i. At this time, the insertion part 5d has a substantially L-shape as seen from the X-axis direction. Further, the end part on the negative side of the Z-axis of the claw part 5j is protruded on the negative side of the Z-axis from the main body 5a.

As shown in FIG. 2 and so on, the aforementioned cage 5 is disposed so as to cover the contact points 2b of the connection substrate 2 from the positive side of the Z-axis, and is fixed to the connection substrate 2 in a state in which the claw parts 5j of the cage 5 are inserted into the penetrating holes 2c of the connection substrate 2.

At this time, when, for example, the cage 5 is bonded to the connection substrate 2 by solder, the solder can be inserted into the folded parts 5i of the insertion parts 5d in the cage 5. It is therefore possible to prevent or reduce the solder from entering the cage 5.

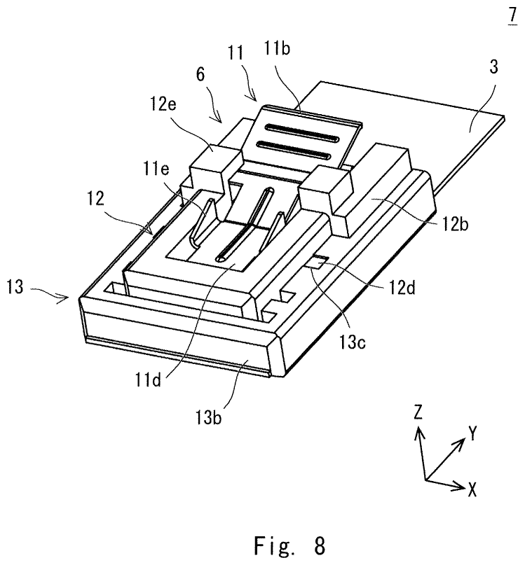

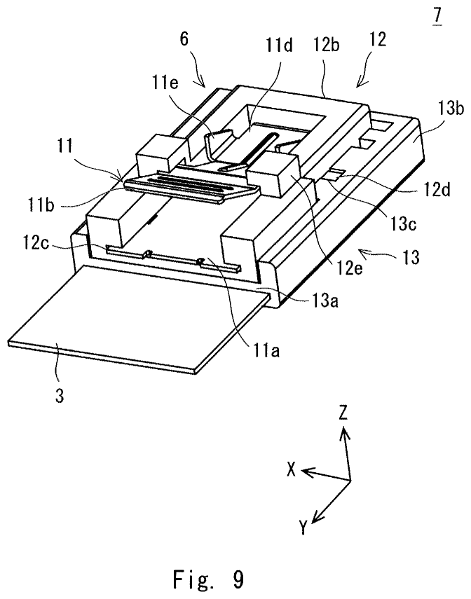

FIG. 8 is a perspective view of the flexible substrate unit of the substrate unit according to this embodiment as seen from the positive side of the Z-axis. FIG. 9 is another perspective view of the flexible substrate unit of the substrate unit according to this embodiment as seen from the positive side of the Z-axis.

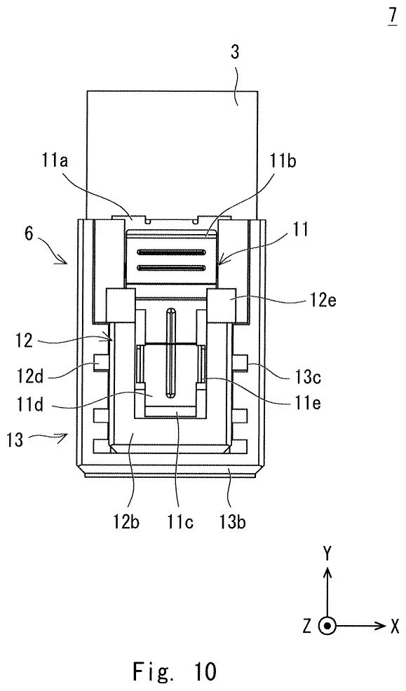

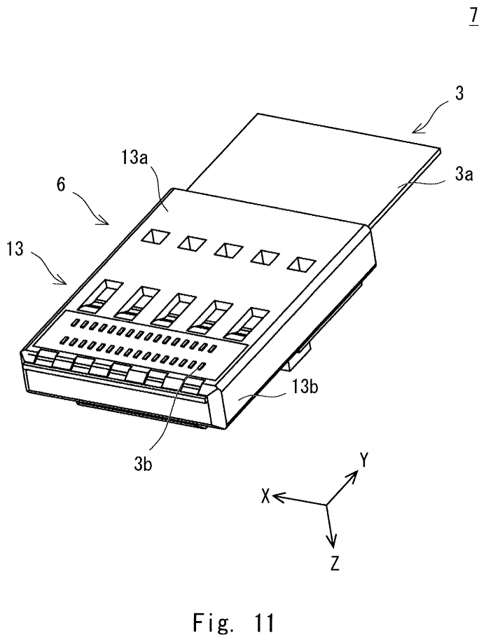

FIG. 10 is a diagram showing the flexible substrate unit of the substrate unit according to this embodiment as seen from the positive side of the Z-axis. FIG. 11 is a perspective view of the flexible substrate unit of the substrate unit according to this embodiment as seen from the negative side of the Z-axis.

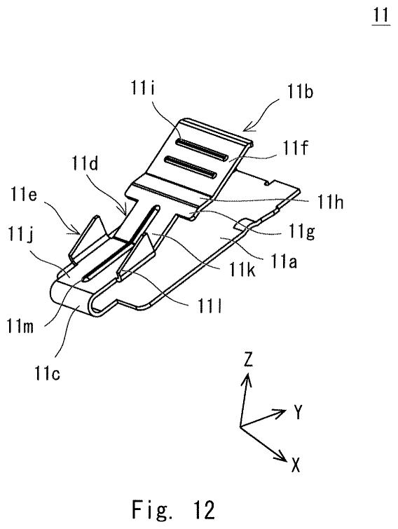

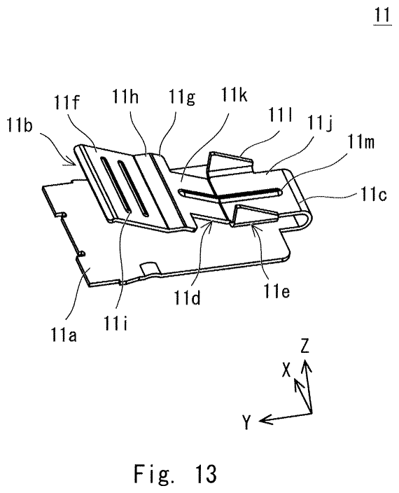

As shown in FIGS. 8 to 11, for example, the housing unit 6 includes an elastic deformation part 11, a first housing 12, and a second housing 13. FIG. 12 is a perspective view showing the elastic deformation part of the fixing structure in the substrate unit according to this embodiment as seen from the positive side of the Z-axis. FIG. 13 is another perspective view showing the elastic deformation part of the fixing structure in the substrate unit according to this embodiment as seen from the positive side of the Z-axis.

The elastic deformation part 11 is made of, for example, an elastically deformable metal. As shown in FIGS. 12 and 13, the elastic deformation part 11 includes a base part 11a, an operation part 11b, a folded part 11c, a connection part 11d, and lock claws 11e. The base part 11a has, for example, a plate shape that is substantially parallel to the XY-plane, and has a substantially rectangular shape as seen from the Z-axis direction.

As shown in FIGS. 12 and 13, for example, the operation part 11b is disposed on the positive side of the Z-axis with respect to the part on the positive side of the Y-axis of the base part 11a. The operation part 11b has a substantially rectangular shape as seen from the Z-axis direction. The operation part 11b has, for example, a plate shape that is inclined in a step shape on the positive side of the Z-axis toward the positive side of the Y-axis.

That is, as shown in FIGS. 12 and 13, for example, the operation part 11b includes a third part 11h that is substantially parallel to the XY-plane between a first part 11f that is inclined on the positive side of the Y-axis and a second part 11g that is inclined on the negative side of the Y-axis.

As shown in FIGS. 12 and 13, for example, convex parts 11i that extend in the X-axis direction may be disposed in the operation part 11b in the Y-axis direction in such a way that they are spaced apart from each other. This structure can prevent an operator's hand from slipping when, for example, the operator operates the elastic deformation part 11 via the operation part 11b.

As shown in FIGS. 12 and 13, for example, the folded part 11c, which has a substantially U-shape whose positive side of the Y-axis is opened as seen from the X-axis direction, is protruded on the positive side of the Z-axis from the end part on the negative side of the Y-axis of the base part 11a. Then, the part of the folded part 11c that is protruded on the positive side of the Z-axis from the base part 11a extends on the positive side of the Y-axis. The folded part 11c has, for example, a substantially rectangular shape as seen from the Z-axis direction.

As shown in FIGS. 12 and 13, for example, the connection part 11d connects the operation part 11b to the folded part 11c. The connection part 11d includes, for example, a first part 11j and a second part 11k.

As shown in FIGS. 12 and 13, for example, the first part 11j has a plate shape that is substantially parallel to the XY-plane. The second part 11k has a plate shape that is inclined on the positive side of the Z-axis toward the positive side of the Y-axis. The connection part 11d has, for example, a substantially rectangular shape as seen from the Z-axis direction.

As shown in FIGS. 12 and 13, for example, the lock claws 11e are protruded on the positive side of the Z-axis from the first part 11j of the connection part 11d. The lock claws 11e are disposed on the respective sides of the first part 11j of the connection part 11d in the X-axis direction.

As shown in FIGS. 12 and 13, for example, the lock claws 11e have a substantially right-angled triangle shape having oblique sides that are inclined on the negative side of the Z-axis toward the negative side of the Y-axis in the end parts on the positive side of the Z-axis of the lock claws 11e as seen from the X-axis direction. Therefore, the lock claws 11e each include an inclined part 11l in the end part on the positive side of the Z-axis of the lock claw 11e.

When the operation part 11b is pushed toward the negative side of the Z-axis in the aforementioned elastic deformation part 11, the folded part 11c is elastically deformed and the lock claws 11e are pushed toward the negative side of the Z-axis. On the other hand, by releasing the pushing of the operation part 11b toward the negative side of the Z-axis, the lock claws 11e are raised toward the positive side of the Z-axis by an elastic force of the folded part 11c.

As shown in FIGS. 12 and 13, a convex part 11m that extends in the Y-axis direction may be formed in the connection part 11d. Accordingly, when the operation part 11b is pushed toward the negative side of the Z-axis, the deformation of the connection part 11d can be prevented or reduced, whereby it is possible to properly push the lock claws 11e toward the negative side of the Z-axis.

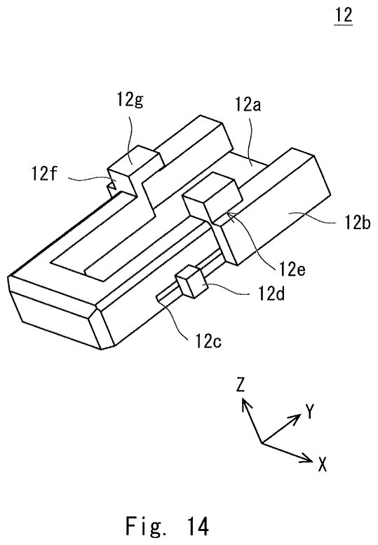

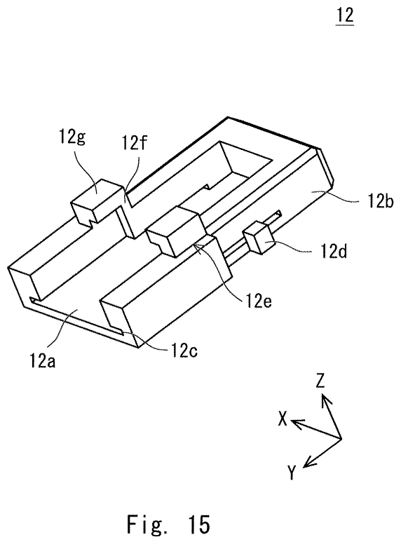

FIG. 14 is a perspective view showing the first housing of the fixing structure in the substrate unit according to this embodiment as seen from the positive side of the Z-axis. FIG. 15 is another perspective view showing the first housing of the fixing structure in the substrate unit according to this embodiment as seen from the positive side of the Z-axis.

The first housing 12 is made of, for example, resin. As shown in FIGS. 14 and 15, the first housing 12 includes a base part 12a, a side wall part 12b, a slit part 12c, engaging parts 12d, and pressing parts 12e.

As shown in FIGS. 14 and 15, for example, the base part 12a has a plate shape that is substantially parallel to the XY-plane, and has a substantially T shape in which the width dimension of the part on the positive side of the Y-axis of the base part 12a is wider than the width dimension of the part on the negative side of the Y-axis of the base part 12a in the X-axis direction as seen from the Z-axis direction.

As shown in FIGS. 14 and 15, the side wall part 12b is protruded on the positive side of the Z-axis from a circumferential part of the base part 12a except for the end part on the positive side of the Y-axis of the base part 12a. That is, the end part on the positive side of the Y-axis of the first housing 12 is opened.

As shown in FIGS. 14 and 15, the slit part 12c is formed in the part on the positive side of the X-axis of the side wall part 12b and the part on the negative side of the X-axis of the side wall part 12b in such a way that the base part 11a of the elastic deformation part 11 can be inserted into the negative side of the Y-axis from the positive side of the Y-axis.

Therefore, as shown in FIG. 15, the slit part 12c extends in the Y-axis direction, and the end part on the positive side of the Y-axis of the slit part 12c reaches the end part on the positive side of the Y-axis of the side wall part 12b. Further, in the slit part 12c, the inner side of the first housing 12 is opened in the X-axis direction as seen from the Y-axis direction.

As shown in FIGS. 14 and 15, the engaging parts 12d are protruded on the outward of the first housing 12 from the part on the positive side of the X-axis of the side wall part 12b and the part on the negative side of the X-axis of the side wall part 12b in the X-axis direction. The engaging parts 12d have, for example, a substantially rectangular shape as seen from the Z-axis direction, and have a thickness in the Z-axis direction.

As shown in FIGS. 14 and 15, the pressing parts 12e are disposed in a step of the part on the positive side of the X-axis of the side wall part 12b and a step of the part on the negative side of the X-axis of the side wall part 12b in such a way that the pressing parts 12e cover the space on the inner side of the first housing 12 formed by the step of the part on the positive side of the X-axis of the side wall part 12b and the space on the inner side of the first housing 12 formed by the step of the part on the negative side of the X-axis of the side wall part 12b from the positive side of the Z-axis.

As shown in FIGS. 14 and 15, for example, the pressing parts 12e each include a first part 12f and a second part 12g. The first part 12f has a substantially L-shape as seen from the Z-axis direction, and is protruded on the positive side of the Z-axis from the step of the part on the positive side of the X-axis of the side wall part 12b and the step of the part on the negative side of the X-axis of the side wall part 12b.

As shown in FIGS. 14 and 15, for example, the second part 12g, which has a plate shape that is substantially parallel to the XY-plane, has a substantially rectangular shape as seen from the Z-axis direction. The second part 12g is protruded on the inward of the first housing 12 from the end part on the positive side of the Z-axis of the first part 12f in the X-axis direction.

In the aforementioned first housing 12, as shown in FIGS. 8 to 10, the end part of the base part 11a of the elastic deformation part 11 in the X-axis direction is inserted into the slit part 12c from the positive side of the Y-axis toward the negative side of the Y-axis, and thus the elastic deformation part 11 is disposed inside the side wall part 12b.

At this time, in the state in which the end part of the third part 11h of the operation part 11b in the X-axis direction is covered by the pressing parts 12e from the positive side of the Z-axis, as shown in FIG. 3, the end part of the third part 11h of the operation part 11b in the X-axis direction contacts the pressing parts 12e. Accordingly, the elastic deformation part 11 is fixed to the first housing 12 in a state in which an elastic force is stored therein.

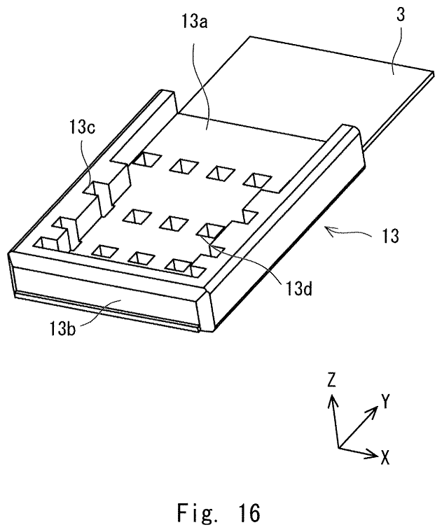

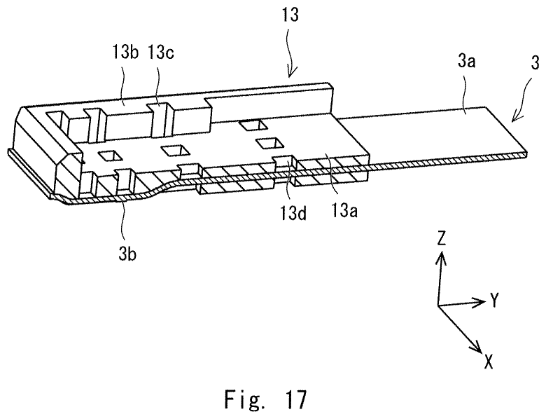

FIG. 16 is a perspective view showing the flexible substrate and the second housing of the fixing structure in the substrate unit according to this embodiment as seen from the positive side of the Z-axis. FIG. 17 is a YZ cross-sectional view of the flexible substrate and the second housing shown in FIG. 16.

As shown in FIGS. 16 and 17, the second housing 13 includes a base part 13a, a side wall part 13b, and engaged parts 13c. The base part 13a, which has a plate shape that is substantially parallel to the XY-plane, has a substantially rectangular shape as seen from the Z-axis direction.

As shown in FIGS. 16 and 17, the side wall part 13b is protruded on the positive side of the Z-axis from a circumferential part of the base part 13a except for the end part on the positive side of the Y-axis of the base part 13a. A space in which the first housing 12 can be disposed is formed inside the side wall part 13b as seen from the Z-axis direction. Therefore, the space inside the side wall part 13b has a substantially T shape corresponding to the shape of the base part 12a of the first housing 12 as seen from the Z-axis direction.

As shown in FIGS. 16 and 17, the engaged parts 13c are cutouts formed in the part on the positive side of the X-axis of the side wall part 13b and the part on the negative side of the X-axis of the side wall part 13b, and the inner side of the second housing 13 is opened in the X-axis direction as seen from the Z-axis direction. The engaged parts 13c have such a shape that the engaging parts 12d of the first housing 12 can be engaged therewith, and have, for example, a substantially rectangular shape as seen from the Z-axis direction.

As shown in FIGS. 16 and 17, the flexible substrate 3 is insert-molded into the aforementioned second housing 13. At this time, as shown in FIGS. 11 and 17, the contact points 3b of the flexible substrate 3 are exposed from the end part on the negative side of the Z-axis of the second housing 13 in a state in which the flexible substrate 3 is accommodated in the base part 13a of the second housing 13.

Here, holes 13d of the second housing 13 shown in FIGS. 16, 17 and so on are traces through which a jig used to fix the position of the flexible substrate 3 is made to pass when the flexible substrate 3 is insert-molded into the second housing 13.

Then, in the second housing 13, in a state in which the first housing 12 is inserted into the side wall part 13b of the second housing 13 from the positive side of the Z-axis toward the negative side of the Z-axis, the engaging parts 12d of the first housing 12 are engaged with the engaged parts 13c of the second housing 13. Accordingly, the first housing 12 is fixed to the second housing 13.

At this time, the outer shape of the part on the negative side of the Y-axis of the first housing 12 and the second housing 13 may be such a shape that they can be inserted into the cage 5 as seen from the Y-axis direction, and may be, for example, substantially equal to the inner shape of the cage 5. The aforementioned housing unit 6 and flexible substrate 3 constitute a flexible substrate unit 7.

Next, a flow of fixing the connection substrate 2 and the flexible substrate 3 via the fixing structure 4 and electrically connecting them will be described. First, the operator pushes the operation part 11b of the elastic deformation part 11 of the flexible substrate unit 7 toward the negative side of the Z-axis and pushes the lock claws 11e toward the negative side of the Z-axis.

Next, the operator inserts the flexible substrate unit 7 into the cage 5 from the positive side of the Y-axis toward the negative side of the Y-axis. Then, the operator releases the pushing of the operation part 11b of the elastic deformation part 11 while further inserting the flexible substrate unit 7 toward the negative side of the Y-axis.

Along with the above operation, the lock claws 11e are raised toward the positive side of the Z-axis by an elastic force of the elastic deformation part 11, and the lock claws 11e are engaged with the lock holes 5c of the cage 5. Accordingly, the position of the flexible substrate unit 7 in the Y-axis direction with respect to the cage 5 is fixed.

At this time, since the lock claws 11e each include the inclined part 11l, the lock claws 11e can be engaged with the lock holes 5c of the cage 5 with a small amount of pushing of the operation part 11b compared to a case in which the lock claws 11e do not include the inclined parts 11l.

Further, as shown in FIG. 3, the contacting part 5f of the pushing part 5b of the cage 5 is pushed up while contacting the end part on the positive side of the Z-axis of the part on the negative side of the Y-axis in the side wall part 12b of the first housing 12 of the flexible substrate unit 7, and the contacting part 5f pushes the housing unit 6 toward the connection substrate 2 by an elastic force of the pushing part 5b of the cage 5. Accordingly, the position of the flexible substrate unit 7 in the Z-axis direction with respect to the cage 5 is fixed.

Here, when the outer shape of the parts on the negative side of the Y-axis of the first housing 12 and the second housing 13 is substantially equal to the inner shape of the cage 5, the housing unit 6 is restrained by the cage 5 in the X-axis direction. Accordingly, the position of the flexible substrate unit 7 in the X-axis direction with respect to the cage 5 is fixed.

Then, the contact points 2b of the connection substrate 2 and the contact points 3b of the flexible substrate 3 overlap each other in the Z-axis direction and are electrically connected to each other. Accordingly, the connection substrate 2 and the flexible substrate 3 can be fixed to each other via the fixing structure 4 and can be electrically connected to each other.

When the flexible substrate unit 7 is inserted into the cage 5 toward the negative side of the Y-axis in the above state, the contact points 3b of the flexible substrate 3 wipe the contact points 2b of the connection substrate 2. Accordingly, the contact points 2b of the connection substrate 2 and the contact points 3b of the flexible substrate 3 can be electrically connected to each other properly.

In addition, when the contact points 2b of the contact point group 2d disposed on the positive side of the Y-axis and the contact points 2b of the contact point group 2d disposed on the negative side of the Y-axis are disposed in such a way that they do not overlap each other as seen from the Y-axis direction, it is possible to prevent the contact points 3b of the flexible substrate 3 from contacting contact points 2b other than the contact points 2b, which are connection targets, of the connection substrate 2.

Further, as described above, the contacting part 5f of the pushing part 5b of the cage 5 pushes the housing unit 6 toward the connection substrate 2, whereby the contact points 2b of the connection substrate 2 and the contact points 3b of the flexible substrate 3 can be electrically connected to each other properly.

Next, a flow of releasing the fixing state of the connection substrate 2 and the flexible substrate 3 will be described. First, the operator pushes the operation part 11b of the elastic deformation part 11 of the flexible substrate unit 7 toward the negative side of the Z-axis and pushes the lock claws 11e toward the negative side of the Z-axis, thereby releasing the engaging state of the lock claws 11e of the housing unit 6 and the lock holes 5c of the cage 5.

Next, the operator pulls out the flexible substrate unit 7 from the cage 5 from the negative side of the Y-axis toward the positive side of the Y-axis. Accordingly, the fixing state of the connection substrate 2 and the flexible substrate 3 can be released. Accordingly, when, for example, the flexible substrate unit 7 fails, this flexible substrate unit 7 can be removed from the connection substrate 2 and easily replaced by a new flexible substrate unit 7.

As described above, the substrate unit 1, the fixing structure 4, and the flexible substrate unit 7 according to this embodiment can fix the position of the flexible substate unit 7 in the Y-axis direction with respect to the connection substrate 2 in a simple configuration in which the lock holes 5c of the cage 5 fixed to the connection substrate 2 and the lock claws 11e of the elastic deformation part 11 of the flexible substrate unit 7 are engaged with each other.

In addition, since the lock claws 11e that are susceptible to damage are disposed on the side of the flexible substrate unit 7 which is less expensive than the connection substrate 2 is, the fixing structure 4 can be repaired at a low cost by exchanging the flexible substrate unit 7 compared to a case in which the connection substrate 2 is exchanged along with the cage 5 when the lock claw 11e is damaged.

Further, the flexible substrate unit 7 is inserted into the cage 5 toward the negative side of the Y-axis, which is substantially parallel to the surface on the positive side of the Z-axis of the connection substrate 2. Accordingly, for example, the height of the working space in the Z-axis direction for connecting the connection substrate 2 to the flexible substrate 3 can be made lower than that in the case in which the flexible substrate unit 7 is made to approach the connection substrate 2 from the positive side of the Z-axis toward the negative side of the Z-axis to be connected.

Further, when the flexible substrate unit 7 is inserted into the cage 5, the contact points 3b of the flexible substrate 3 wipe the contact points 2b of the connection substrate 2. Accordingly, the contact points 2b of the connection substrate 2 and the contact points 3b of the flexible substrate 3 can be electrically connected to each other properly.

Further, when the contact points 2b of the contact point group 2d disposed on the positive side of the Y-axis and the contact points 2b of the contact point group 2d disposed on the negative side of the Y-axis are disposed in such a way that they do not overlap each other as seen from the Y-axis direction, it is possible to prevent the contact points 3b of the flexible substrate 3 from contacting contact points 2b other than the contact points 2b, which are connection targets, of the connection substrate 2.

Further, when the connection substrate 2 and the flexible substrate 3 are fixed via the fixing structure 4, the contacting part 5f pushes the flexible substrate unit 7 toward the connection substrate 2 by an elastic force of the pushing part 5b of the cage 5.

Accordingly, the position of the flexible substrate unit 7 in the Z-axis direction with respect to the connection substrate 2 can be fixed, and the contact points 2b of the connection substrate 2 and the contact points 3b of the flexible substrate 3 can be electrically connected to each other properly.

Further, when the elastic deformation part 11 includes the operation part 11b, the lock claws 11e can be easily displaced in the Z-axis direction. Further, when the flexible substrate 3 is insert-molded into the second housing 13, the flexible substrate 3 and the second housing 13 can be easily integrated.

### Second Embodiment

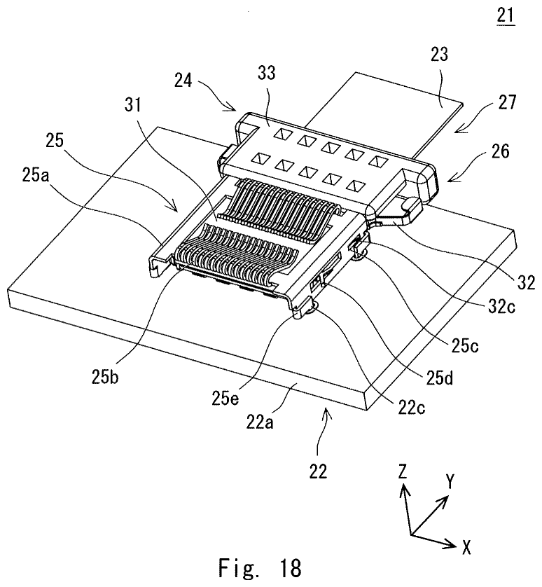

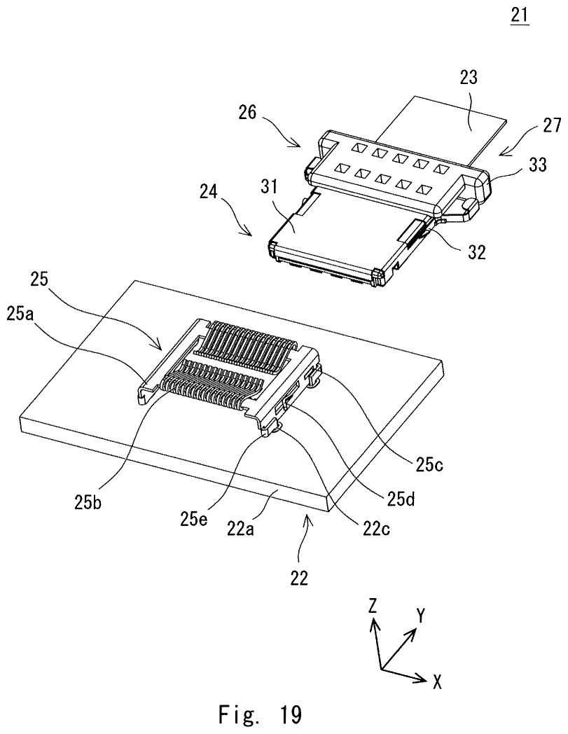

FIG. 18 is a perspective view showing a state in which a flexible substrate unit is fixed to a connection substrate in a substrate unit according to this embodiment as seen from a positive side of a Z-axis. FIG. 19 is a perspective view showing a state before a housing of the flexible substrate unit is inserted into a cage fixed to the connection substrate in the substrate unit according to this embodiment as seen from the positive side of the Z-axis.

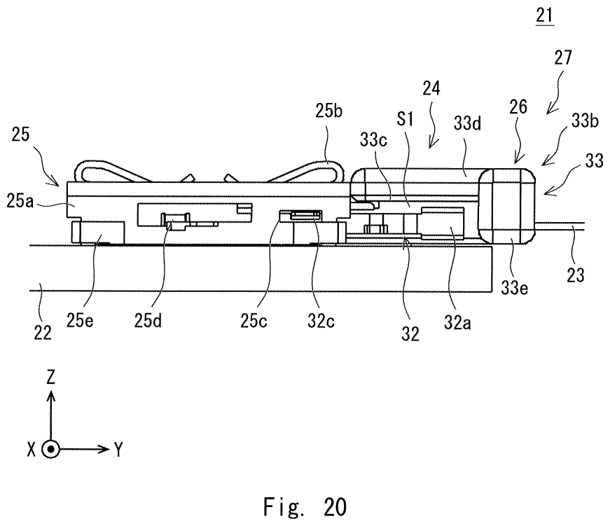

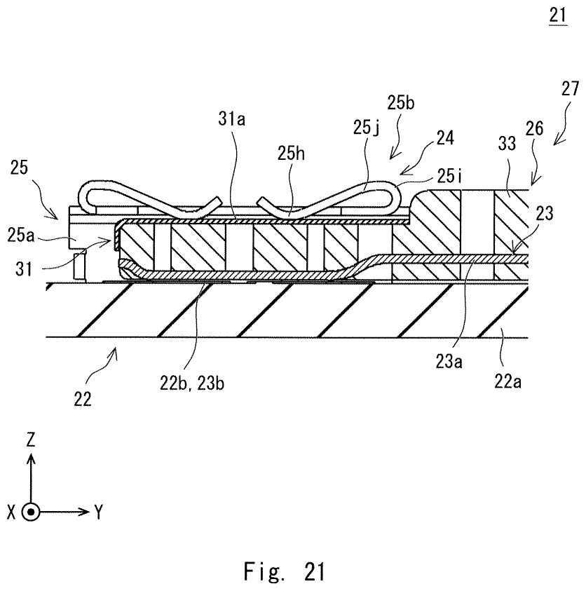

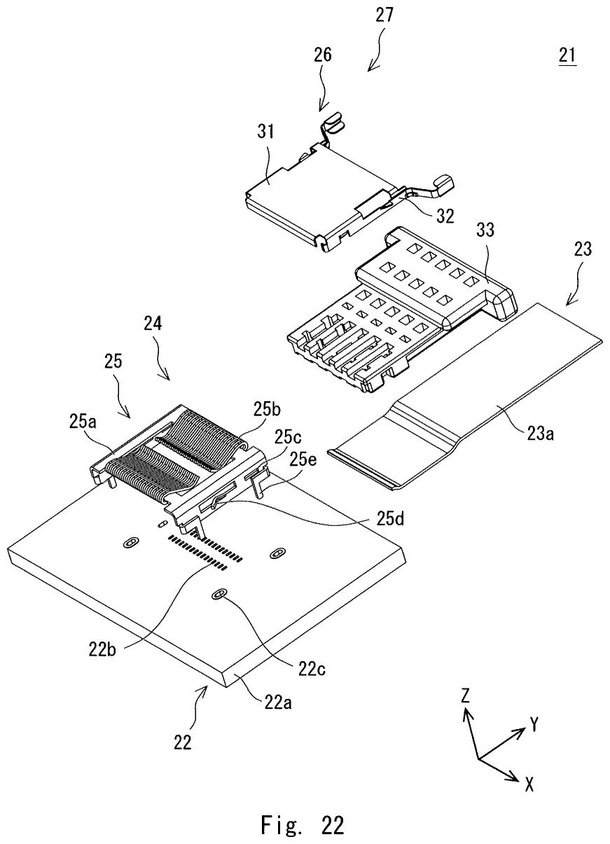

FIG. 20 shows a state in which the flexible substrate unit is fixed to the connection substrate in the substrate unit according to this embodiment as seen from the positive side of the X-axis. FIG. 21 is a YZ cross-sectional view of the substrate unit shown in FIG. 18. FIG. 22 is an exploded perspective view showing the substrate unit according to this embodiment as seen from the positive side of the Z-axis.

As shown in FIGS. 18 to 22, for example, a substrate unit 21 includes a connection substrate 22, a flexible substrate 23, and a fixing structure 24. While the detailed descriptions of the connection substrate 22 will be omitted since the connection substrate 22 has, for example, a configuration that is substantially equal to that of the connection substrate 2 according to the first embodiment, the connection substrate 22 includes a main body 22a, contact points 22b, and penetrating holes 22c.

As shown in FIGS. 21 and 22, for example, the flexible substrate 23 has a configuration that is substantially equal to that of the flexible substrate 3 according to the first embodiment, and includes a main body 23a and contact points 23b. The fixing structure 24 includes a cage 25 and a housing unit 26.

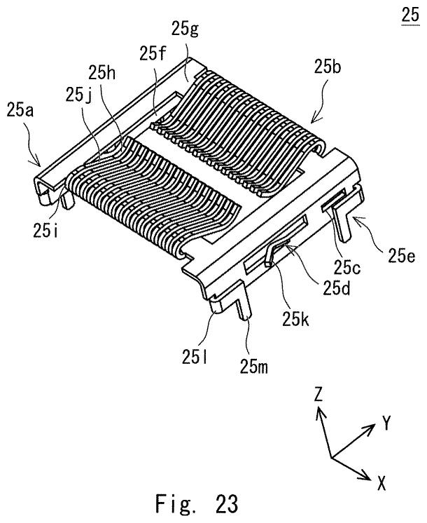

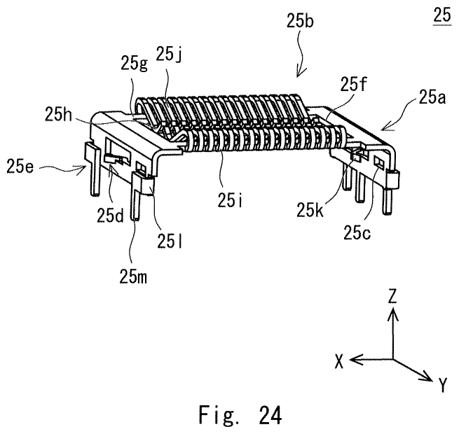

FIG. 23 is a perspective view showing the cage of the fixing structure in the substrate unit according to this embodiment as seen from the positive side of the Z-axis. FIG. 24 is another perspective view showing the cage of the fixing structure in the substrate unit according to this embodiment as seen from the positive side of the Z-axis.

The cage 25 is made of, for example, metal. As shown in FIGS. 22 to 24, the cage 25 includes a main body 25a, pushing parts 25b, lock holes 25c, pinching parts 25d, and insertion parts 25e. The main body 25a has a semi-cylindrical shape whose negative side of the Z-axis is opened and extends in the Y-axis direction.

As shown in FIGS. 22 to 24, for example, the main body 25a has a substantially rectangular shape as seen from the Y-axis direction, and an opening part 25f is formed in the end part on the positive side of the Z-axis of the main body 25a. The opening part 25f has a substantially rectangular shape as seen from the Z-axis direction.

Therefore, as shown in FIGS. 22 to 24, the main body 25a incudes beam parts 25g on the respective sides of the opening part 25f in the Y-axis direction, and has, for example, a substantially # shape as seen from the Z-axis direction. The beam parts 25g extend in the X-axis direction.

As shown in FIGS. 22 to 24, the pushing parts 25b are plate springs that extend from the beam parts 25g of the main body 25a toward the inner side of the main body 25a in the Y-axis direction so as to cover the opening part 25f of the main body 25a from the positive side of the Z-axis.

As shown in FIGS. 22 to 24, for example, the pushing parts 25b each include a contacting part 25h, a folded part 25i, and a connection part 25j. The contacting part 25h is disposed inside the opening part 25f as seen from the Z-axis direction. The contacting part 25h has, for example, a substantially C-shape whose positive side of the Z-axis is released as seen from the X-axis direction.

As shown in FIGS. 22 to 24, the folded parts 25i, which have a substantially U-shape in which the inner side of the main body 25a is opened as seen from the X-axis direction, are protruded on the positive side of the Z-axis from the beam parts 25g. The part of the folded part 25i that is protruded on the positive side of the Z-axis from the beam part 25g extends toward the inner side of the main body 25a from the beam part 25g in the Y-axis direction. The connection part 25j connects the contacting part 25h to the folded part 25i.

As shown in FIGS. 22 to 24, the aforementioned pushing parts 25b are disposed in the X-axis direction in such a way that they are spaced apart from each other in a state in which they are opposed to each other in the Y-axis direction. At this time, the end part on the negative side of the Z-axis of the contacting parts 25h is protruded on the negative side of the Z-axis from the opening part 25f as seen from the X-axis direction.

As shown in FIGS. 22 to 24, the lock holes 25c are formed in a side wall part on the positive side of the X-axis of the main body 25a and a side wall part on the negative side of the X-axis of the main body 25a. The lock holes 25c are disposed, for example, in a part on the positive side of the Y-axis of the main body 25a as seen from the X-axis direction. The lock holes 25c have, for example, a substantially rectangular shape that is long in the Y-axis direction as seen from the Z-axis direction.

As will be described later, the pinching parts 25d pinch the housing unit 26 inserted into the cage 25 from the X-axis direction. Therefore, as shown in FIGS. 22 to 24, the pinching parts 25d are formed of pinching pieces 25k disposed in the X-axis direction in such a way that they are spaced apart from each other.

As shown in FIGS. 22 to 24, for example, the pinching pieces 25k are formed by cutting out the side wall part on the positive side of the X-axis of the main body 25a and the side wall part on the negative side of the X-axis of the main body 25a. The pinching pieces 25k are, for example, plate springs that are extended in the Y-axis direction.

As shown in FIGS. 22 to 24, for example, the pinching pieces 25k have a substantially C-shape in which the outer side of the main body 25a is opened in the X-axis direction as seen from the Z-axis direction. The end part on the positive side of the Y-axis of each of the pinching pieces 25k is fixed to the side wall part on the positive side of the X-axis or the side wall part on the negative side of the X-axis of the main body 25a.

As shown in FIGS. 23 and 24, the end part of each of the pinching pieces 25k on the inner side of the main body 25a is protruded on the inward of the main body 25a from the side wall part on the positive side of the X-axis or the side wall part on the negative side of the X-axis of the main body 25a.

As shown in FIGS. 22 to 24, the insertion parts 25e are protruded on the negative side of the Z-axis from the main body 25a in such a way that the insertion parts 25e can be inserted into the penetrating holes 22c of the connection substrate 22. Here, the insertion parts 25e disposed in four corners of the main body 25a have a configuration that is substantially equal to that of the insertion parts 5d of the cage 5 according to the first embodiment, and the insertion parts 25e may each include a folded part 25l and a claw part 25m.

As shown in FIG. 19, the aforementioned cage 25 is disposed so as to cover the contact points 22b of the connection substrate 22 from the positive side of the Z-axis, and the cage 25 is fixed to the connection substrate 22 in a state in which the insertion parts 25e of the cage 25 are inserted into the penetrating holes 22c of the connection substrate 22.

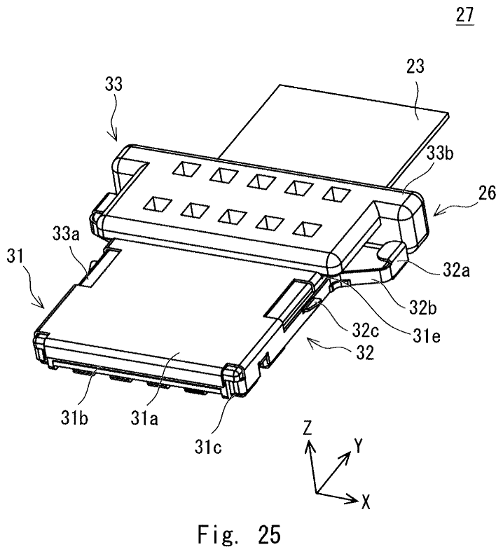

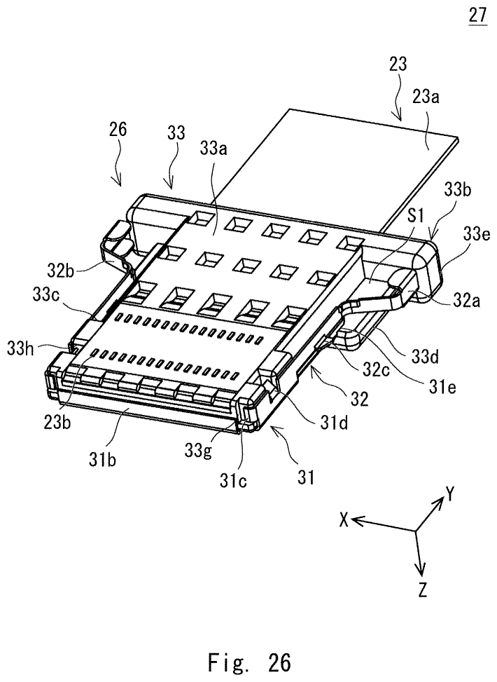

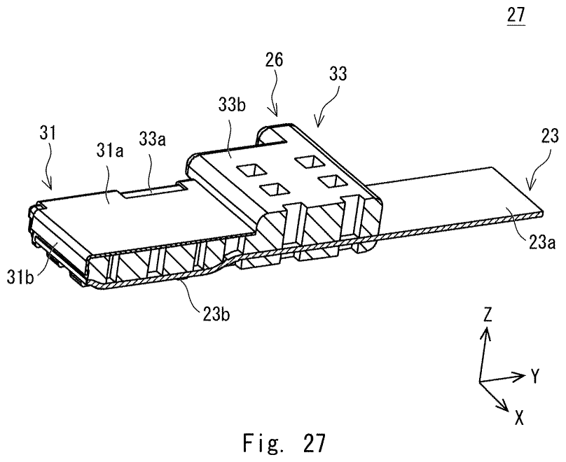

FIG. 25 is a perspective view of the flexible substrate unit of the substrate unit according to this embodiment as seen from the positive side of the Z-axis. FIG. 26 is a perspective view of the flexible substrate unit of the substrate unit according to this embodiment as seen from the negative side of the Z-axis. FIG. 27 is a YZ cross-sectional view of the flexible substrate unit shown in FIG. 25.

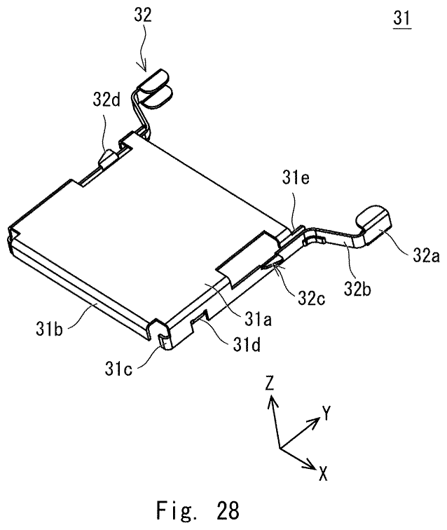

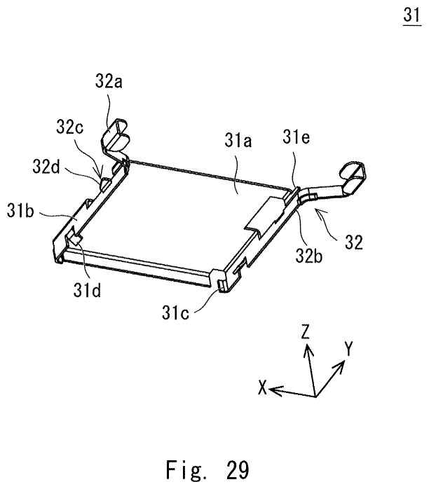

As shown in FIGS. 25 to 27, for example, the housing unit 26 includes a shell 31, an elastic deformation part 32, and a housing 33. FIG. 28 is a perspective view showing the shell and the elastic deformation part of the fixing structure in the substrate unit according to this embodiment as seen from the positive side of the Z-axis. FIG. 29 is a perspective view showing the shell and the elastic deformation part of the fixing structure in the substrate unit according to this embodiment as seen from the negative side of the Z-axis.

The shell 31 is made of, for example, metal. As shown in FIGS. 28 and 29, the shell 31 includes a cover part 31a, side wall parts 31b, a first engaging part 31c, and a second engaging part 31d. The cover part 31a has a plate shape that is substantially parallel to the XY-plane, and has, for example, a substantially rectangular shape as seen from the Z-axis direction.

As shown in FIGS. 28 and 29, for example, the side wall parts 31b have a substantially L-shape as seen from one of the X-axis direction or the Y-axis direction. The side wall parts 31b are suspended, for example, on the negative side of the Z-axis from the end part on the negative side of the Y-axis of the cover part 31a, the end part on the positive side of the X-axis of the cover part 31a, and the end part on the negative side of the X-axis of the cover part 31a.

At this time, as shown in FIGS. 28 and 29, the side wall parts 31b that are suspended from the end part of the cover part 31a in the X-axis direction are disposed in such a way that they are spaced apart from each other in the Y-axis direction. The side wall parts 31b have, for example, a substantially rectangular shape as seen from the other one of the X-axis direction or the Y-axis direction.

Note that, as shown in FIGS. 28 and 29, the side wall part 31b that is suspended from the end part of the cover part 31a in the X-axis direction and is disposed on the positive side of the Y-axis may include a cutout 31e in the corner part on the positive side of the Z-axis on the positive side of the Y-axis.

Then, as shown in FIGS. 28 and 29, the height of the side wall part 31b in the Z-axis direction that is suspended from the end part of the cover part 31a in the X-axis direction and is disposed on the positive side of the Y-axis may be lower than the height of the side wall part 31b in the Z-axis direction that is suspended from the end part of the cover part 31a in the X-axis direction and is disposed on the negative side of the Y-axis.

As shown in FIGS. 28 and 29, for example, the first engaging parts 31c have a substantially L-shape as seen from the Z-axis direction. The first engaging parts 31c are protruded on the negative side of the Y-axis from the side wall part 31b that is suspended from the end part of the cover part 31a in the X-axis direction and is disposed on the negative side of the Y-axis.

Further, as shown in FIGS. 28 and 29, for example, the first engaging parts 31c are protruded in the X-axis direction on the inward of the shell 31 from the side wall part 31b that is suspended from the end part of the cover part 31a in the X-axis direction and is disposed on the negative side of the Y-axis. The first engaging parts 31c have, for example, a substantially rectangular shape as seen from the X-axis direction and the Y-axis direction.

As shown in FIGS. 28 and 29, for example, the second engaging parts 31d are each formed by cutting out the side wall part 31b that is suspended from the end part of the cover part 31a in the X-axis direction and is disposed on the negative side of the Y-axis, and are inclined on the inward the shell 31 toward the negative side of the Z-axis as seen from the Y-axis direction. The second engaging parts 31d have, for example, a substantially rectangular shape as seen from the X-axis direction.

As shown in FIGS. 28 and 29, for example, the elastic deformation parts 32 are disposed on the respective sides of the cover part 31a in the X-axis direction. The elastic deformation parts 32 each include an operation part 32a, a connection part 32b, and a lock claw 32c. The operation part 32a has, for example, a substantially C-shape in which the inner side of the shell 31 is opened in the X-axis direction as seen from the Y-axis direction.

As shown in FIGS. 28 and 29, for example, the operation parts 32a have a substantially rectangular shape as seen from the X-axis direction. The connection parts 32b have a substantially L-shape as seen from the Z-axis direction. That is, the connection parts 32b extend on the positive side of the Y-axis from the side wall part 31b that is suspended from the end part of the cover part 31a in the X-axis direction and is disposed on the negative side of the Y-axis, and extend toward the outer side of the shell 31 in the X-axis direction.

As shown in FIGS. 28 and 29, the operation parts 32a are fixed to the end parts on the positive side of the Y-axis of the connection parts 32b. Then, the connection parts 32b are disposed in the space on the negative side of the Z-axis with respect to the side wall part 31b that is suspended from the end part of the cover part 31a in the X-axis direction and is disposed on the positive side of the Y-axis. The connection part 32b has a substantially rectangular shape as seen from the X-axis direction.

As shown in FIGS. 28 and 29, for example, the lock claws 32c are each protruded on the outward of the shell 31 from the part on the negative side of the Y-axis of the connection part 32b in the X-axis direction. The lock claws 32c have a substantially right-angled triangle shape having oblique sides that are inclined on the inward of the shell 31 in the X-axis direction toward the negative side of the Y-axis in the end part on the negative side of the Y-axis of the lock claws 32c as seen from the Z-axis direction. Therefore, the lock claws 32c each include an inclined part 32d in the end part on the negative side of the Y-axis of the lock claw 32c.

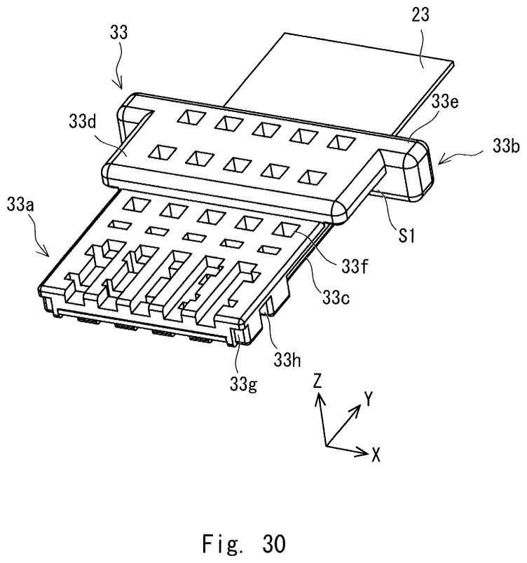

FIG. 30 is a perspective view showing the flexible substrate and the housing of the fixing structure in the substrate unit according to this embodiment as seen from the positive side of the Z-axis. As shown in FIG. 30, the housing 33 includes a base part 33a and a protection unit 33b.

As shown in FIG. 30, for example, the base part 33a has a plate shape that is substantially parallel to the XY-plane, and has a substantially rectangular shape as seen from the Z-axis direction. Cutouts 33c are formed in the end parts of the base part 33a in the X-axis direction.

As shown in FIG. 26, the cutouts 33c are disposed on the parts on the negative side of the Z-axis on the positive side of the Y-axis of the base part 33a as seen from the X-axis direction. The cutouts 33c extend in the Y-axis direction, and the end part on the positive side of the Y-axis of each of the cutouts 33c reaches the end part on the positive side of the Y-axis of the base part 33a.

As shown in FIG. 30, the protection unit 33b includes a first part 33d and a second part 33e. The first part 33d, which has a plate shape that is substantially parallel to the XY-plane, has a substantially rectangular shape as seen from the Z-axis direction.

As shown in FIG. 30, the first part 33d, which is disposed in the part on the positive side of the Y-axis of the base part 33a, is fixed to the end part on the positive side of the Z-axis of the base part 33a. The first part 33d is protruded on the outward of the base part 33a from the base part 33a in the X-axis direction.

As shown in FIG. 30, the second part 33e, which has a substantially rectangular shape as seen from the Y-axis direction, has a thickness in the Y-axis direction. The second part 33e, which is disposed in the end part on the positive side of the Y-axis of the first part 33d, is protruded on the outward of the first part 33d from the first part 33d in the X-axis direction.

At this time, as shown in FIG. 26, the end part on the negative side of the Z-axis of the second part 33e is disposed at substantially the same height as that of the end part on the negative side of the Z-axis of the base part 33a in the Z-axis direction. Accordingly, the cutout 33c of the base part 33a, the first part 33d of the protection unit 33b, and the second part 33e of the protection unit 33b form a space S1.

As shown in FIG. 27, the flexible substrate 23 is insert-molded into the aforementioned housing 33. At this time, the contact points 23b of the flexible substrate 23 are exposed from the end part on the negative side of the Z-axis of the housing 33 in a state in which the flexible substrate 23 is accommodated in the base part 33a of the housing 33.

Here, holes 33f of the housing 33 shown in FIG. 30 and so on are traces through which a jig used to fix the position of the flexible substrate 23 is made to pass when the flexible substrate 23 is insert-molded into the housing 33.

As shown in FIGS. 25 and 27, the shell 31 is fixed to the housing 33, and the cover part 31a of the shell 31 covers the base part 33a of the housing 33 from the positive side of the Z-axis. At this time, as shown in FIG. 26, the first engaging parts 31c of the shell 31 are engaged with the first engaged parts 33g formed in the corner parts on the negative side of the Y-axis of the housing 33, and the second engaging parts 31d are engaged with the second engaged parts 33h formed in the end part of the housing 33 in the X-axis direction.

Further, as shown in FIGS. 25 and 26, the first part 33d of the protection unit 33b of the housing 33 is engaged with the cutout 31e formed in the side wall part 31b that is suspended from the end part of the cover part 31a in the housing 33 in the X-axis direction and is disposed on the positive side of the Y-axis. Accordingly, the shell 31 can be firmly fixed to the housing 33.

Then, the elastic deformation parts 32 are disposed so as to overlap the cutouts 33c of the housing 33 as seen from the X-axis direction, and the elastic deformation parts 32 can be displaced on the inner side of the housing 33 using the cutouts 33c formed in the base part 33a in the housing 33 in the X-axis direction.

Further, as shown in FIGS. 25 and 26, the bending parts of the connection parts 32b in the elastic deformation parts 32 are covered by the first part 33d of the protection unit 33b of the housing 33 from the positive side of the Z-axis in a state in which the bending parts of the connection parts 32b in the elastic deformation parts 32 are disposed inside the space S1.

Further, as shown in FIGS. 25 and 26, the operation parts 32a of the elastic deformation parts 32 are covered by the second part 33e of the protection unit 33b of the housing 33 from the positive side of the Y-axis. The housing unit 26 and the flexible substrate 23 constitute a flexible substrate unit 27.

Next, a flow of fixing the connection substrate 22 and the flexible substrate 23 via the fixing structure 24 and electrically connecting them will be described. First, the operator pushes the operation parts 32a of the elastic deformation parts 32 of the flexible substrate unit 27 toward the inner side of the housing 33 in the X-axis direction and pushes the lock claws 32c toward the inner side of the housing 33.

At this time, since the cutouts 33c are formed in the base part 33a of the housing 33, the elastic deformation parts 32 can be displaced on the inner side of the housing 33 properly in the X-axis direction.

Next, the operator inserts the flexible substrate unit 27 into the cage 25 from the positive side of the Y-axis toward the negative side of the Y-axis. Then, the operator releases the pushing of the operation parts 32a of the elastic deformation parts 32 while further inserting the flexible substrate unit 27 toward the negative side of the Y-axis.

In accordance therewith, the lock claws 32c are pulled toward the outer side of the housing 33 by an elastic force of the elastic deformation parts 32 in the X-axis direction, and the lock claws 32c are engaged with the lock holes 25c of the cage 25. Accordingly, the position of the flexible substrate unit 27 in the Y-axis direction with respect to the cage 25 is fixed.

At this time, since the lock claws 32c include the inclined parts 32d, the lock claws 32c can be engaged with the lock holes 25c of the cage 25 with a small amount of pushing of the operation part 32a compared to the case in which the lock claws 32c do not include the inclined parts 32d.

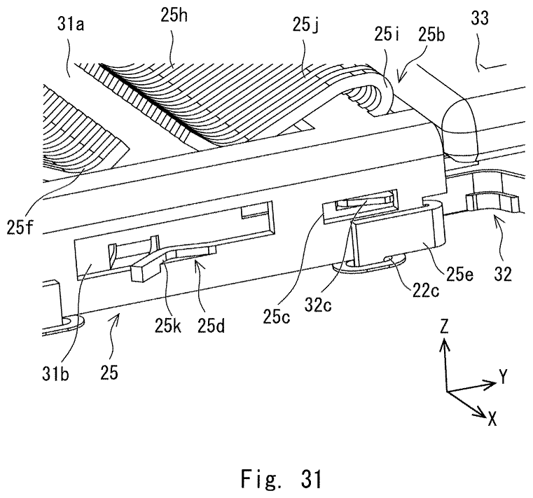

Here, FIG. 31 is a perspective view showing a state in which the lock claws of the flexible substrate unit are engaged with the lock holes of the cage in the substrate unit according to this embodiment as seen from the positive side of the Z-axis. As shown in FIG. 31, the pinching piece 25k of the cage 25 contacts the side wall part 31b that is suspended from the end part of the shell 31 in the X-axis direction and disposed on the negative side of the Y-axis, and the pinching part 25d of the cage 25 pinches the housing unit 26 in the X-axis direction. Accordingly, the position of the flexible substrate unit 27 in the X-axis direction with respect to the cage 25 is fixed.

In addition, as shown in FIG. 21, the contacting part 25h of the pushing part 25b of the cage 25 contacts the cover part 31a of the shell 31 of the flexible substrate unit 27, and pushes the housing unit 26 toward the connection substrate 22 by an elastic force of the pushing part 25b of the cage 25. Accordingly, the position of the flexible substrate unit 27 in the Z-axis direction with respect to the cage 25 is fixed.

At this time, the contacting part 25h of the pushing part 25b of the cage 25 contacts the cover part 31a of the shell 31 that covers the base part 33a of the housing 33 in the flexible substrate unit 27, whereby it is possible to prevent or reduce damage in the base part 33a of the housing 33. That is, the cover part 31a of the shell 31 can function as a contacting part that the pushing part 25b of the cage 25 contacts.

Further, the contact points 22b of the connection substrate 22 and the contact points 23b of the flexible substrate 23 overlap each other in the Z-axis direction and are electrically connected to each other. Accordingly, the connection substrate 22 and the flexible substrate 23 can be fixed via the fixing structure 24 and can be electrically connected to each other.

At this time, since the housing unit 26 is pushed toward the connection substrate 22 by an elastic force of the pushing part 25b of the cage 25 as described above, the contact points 22b of the connection substrate 22 and the contact points 23b of the flexible substrate 23 can be electrically connected to each other properly.

Next, a flow of releasing the fixing state of the connection substrate 22 and the flexible substrate 23 will be described. First, the operator pushes the operation parts 32a of the elastic deformation parts 32 of the flexible substrate unit 27 toward the inner side of the housing 33 and pushes the lock claws 32c toward the inner side of the housing 33 in the X-axis direction, and releases the engagement of the lock claws 32c of the housing unit 26 and the lock holes 25c of the cage 25.

Next, the operator pulls the flexible substrate unit 27 from the cage 25 from the negative side of the Y-axis toward the positive side of the Y-axis. Accordingly, the fixing state of the connection substrate 22 and the flexible substrate 23 can be released. Then, when, for example, the flexible substrate unit 27 fails, this flexible substrate unit 27 can be removed from the connection substrate 22 and easily replaced by a new flexible substrate unit 27.

As described above, with the substrate unit 21, the fixing structure 24, and the flexible substrate unit 27 according to this embodiment, the position of the flexible substrate unit 27 in the Y-axis direction with respect to the connection substrate 22 can be fixed in a simple configuration in which the lock holes 25c of the cage 25 fixed to the connection substrate 22 and the lock claws 32c of the elastic deformation parts 32 of the flexible substrate unit 27 engage with each other.

In addition, since the base part 33a of the housing 33 is covered with the cover part 31a of the shell 31, the damage in the base part 33a of the housing 33 when the contacting part 25h of the pushing part 25b of the cage 25 contacts the housing unit 26 can be prevented or reduced.

Further, when the operation parts 32a of the elastic deformation parts 32 are covered by the second part 33e of the protection unit 33b of the housing 33 from the positive side of the Y-axis and the bending parts of the connection parts 32b of the elastic deformation parts 32 are covered by the first part 33d of the protection unit 33b of the housing 33 from the positive side of the Z-axis, it is possible to prevent or reduce other elements from unexpectedly contacting the operation parts 32a or the connection parts 32b of the elastic deformation parts 32 and the connection of the cage 25 with the flexible substrate unit 27 from being released.

### Third Embodiment

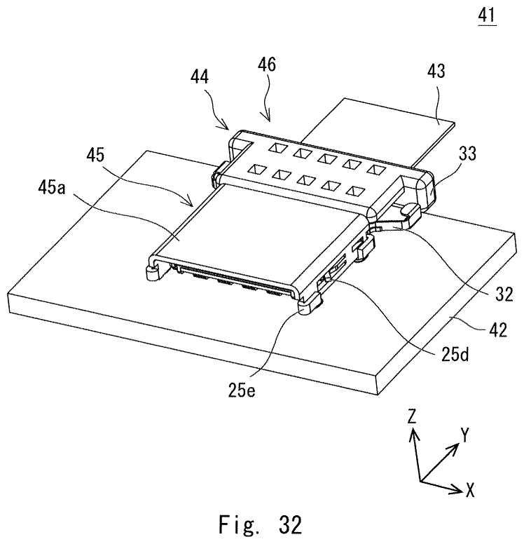

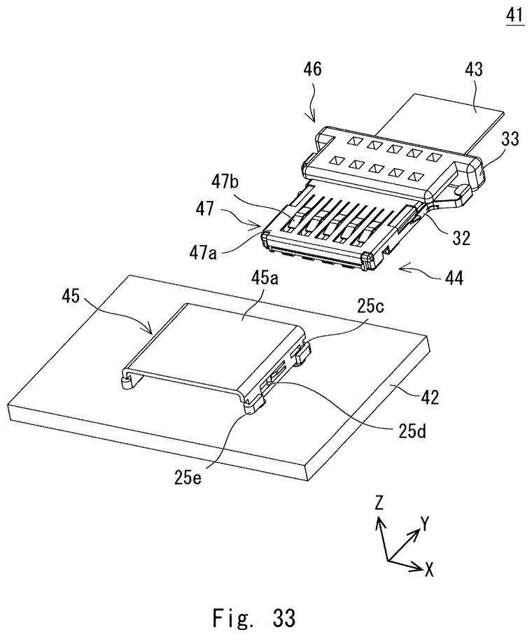

FIG. 32 is a perspective view showing a state in which a flexible substrate unit is fixed to a connection substrate in a substrate unit according to this embodiment as seen from a positive side of a Z-axis. FIG. 33 is a perspective view showing a state before a housing of the flexible substrate unit is inserted into a cage fixed to the connection substrate in the substrate unit according to this embodiment as seen from the positive side of the Z-axis.

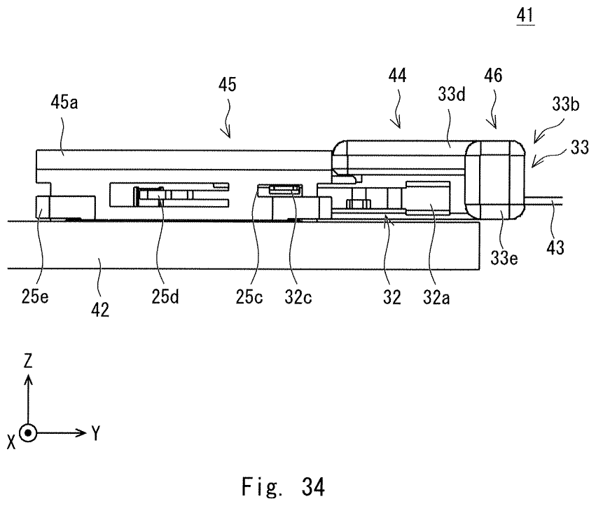

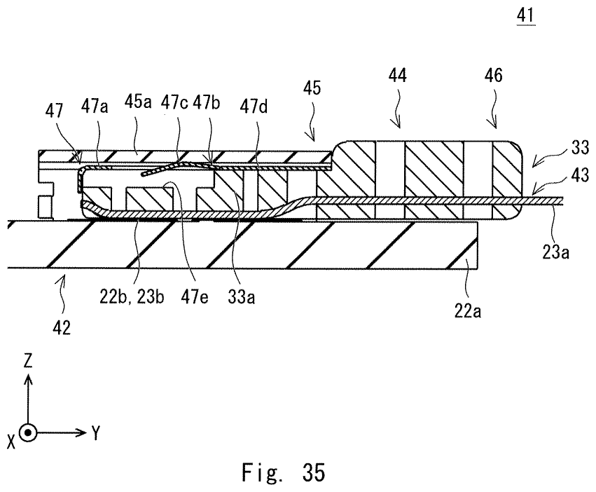

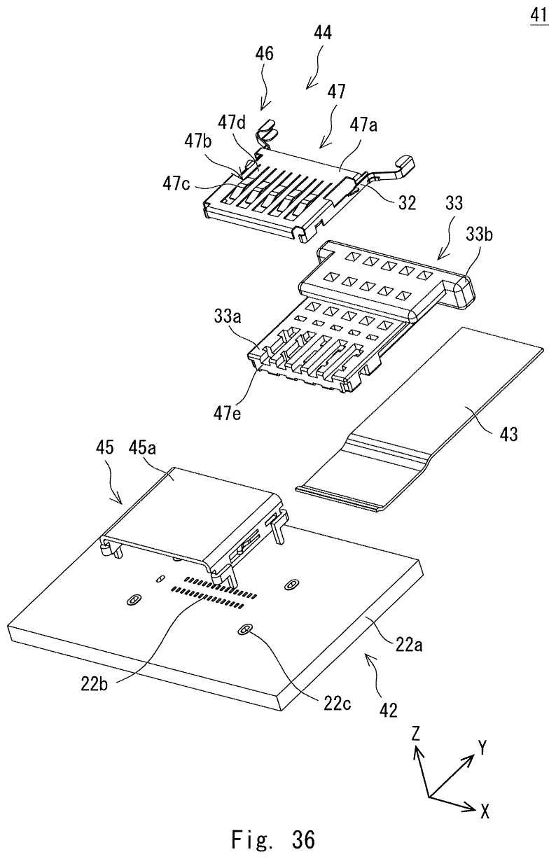

FIG. 34 shows a state in which the flexible substrate unit is fixed to the connection substrate in the substrate unit according to this embodiment as seen from the positive side of the X-axis. FIG. 35 is a YZ cross-sectional view of the substrate unit shown in FIG. 32. FIG. 36 is an exploded perspective view of the substrate unit according to this embodiment as seen from the positive side of the Z-axis.

As shown in FIGS. 32 to 36, for example, a substrate unit 41 includes a connection substrate 42, a flexible substrate 43, and a fixing structure 44. Since the substrate unit 41 has a configuration that is substantially equal to that of the substrate unit 21 according to the second embodiment, redundant descriptions will be omitted and the same reference symbols are attached to the same elements.

As shown in FIGS. 32 to 36, for example, the connection substrate 42 and the flexible substrate 43 have configurations that are substantially equal to that of the connection substrate 2 and the flexible substrate 3 according to the first embodiment. The fixing structure 44 includes a cage 45 and a housing unit 46.

While the cage 45 has a configuration that is substantially equal to that of the cage 25 according to the second embodiment, as shown in FIGS. 32 to 36, a main body 45a is different from the main body 25a of the cage 25 according to the second embodiment in that the opening part 25f and the pushing part 25b provided in the main body 25a of the cage 25 are omitted in the main body 45a.

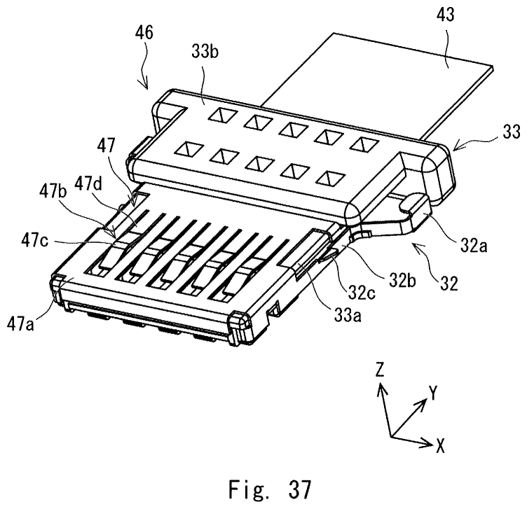

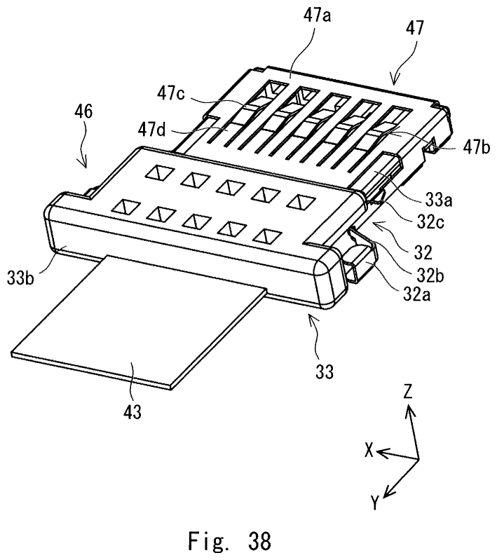

FIG. 37 is a perspective view of the flexible substrate unit of the substrate unit according to this embodiment as seen from the positive side of the Z-axis. FIG. 38 is another perspective view showing the flexible substrate unit of the substrate unit according to this embodiment as seen from the positive side of the Z-axis.

While the housing unit 46 has a configuration that is substantially equal to that of the housing unit 26 according to the second embodiment, as shown in FIGS. 36 to 38, for example, a cover part 47a of a shell 47 is different from the cover part 31a of the shell 31 according to the second embodiment in that pushing parts 47b are formed in the cover part 47a of the shell 47.

As shown in FIGS. 36 to 38, for example, the pushing parts 47b are plate springs that are formed by cutting out the cover part 47a of the shell 47 and extend in the Y-axis direction. The pushing parts 47b each include a contacting part 47c and a connection part 47d.

Here, the housing 33 according to the second embodiment can be used as a housing of the housing unit 46. As shown in FIG. 36, grooves 47e for allowing the pushing parts 47b to be displaced on the negative side of the Z-axis are formed in a base part 33a of the housing 33.

As shown in FIG. 36, the grooves 47e extend in the Y-axis direction, and are disposed in such a way that they are spaced apart from each other in the X-direction. The width dimension of the grooves 47e in the X-axis direction is greater than the width dimension of the pushing parts 47b in the X-axis direction.

As shown in FIGS. 36 to 38, for example, the contacting parts 47c have a substantially C-shape whose negative side of the Z-axis is opened as seen from the X-axis direction. The end parts on the positive side of the Z-axis of the contacting parts 47c are protruded on the positive side of the Z-axis from the cover part 47a of the shell 47.

As shown in FIG. 35, for example, the contacting parts 47c are disposed so as to overlap the grooves 47e of the housing 33 as seen from the Z-axis direction, and cover the grooves 47e of the housing 33 from the positive side of the Z-axis.

As shown in FIGS. 36 to 38, the connection parts 47d extend in the Y-axis direction. The end parts on the positive side of the Y-axis of the connection parts 47d are fixed to the cover part 47a of the shell 47. The end parts on the negative side of the Y-axis of the connection parts 47d are fixed to the end parts on the positive side of the Y-axis of the contacting parts 47c.

When the connection substrate 42 and the flexible substrate 43 are fixed to each other via the fixing structure 44 and are electrically connected to each other in the aforementioned substrate unit 41, the contacting parts 47c of the pushing parts 47b of the shell 47 contact the main body 45a of the cage 45, and the housing unit 46 is pushed toward the connection substrate 42 by an elastic force of the pushing parts 47b of the shell 47, which is substantially equal to the substrate unit 21 according to the second embodiment.

With the substrate unit 41, the fixing structure 44, and the flexible substrate unit according to this embodiment as well, the position of the flexible substrate unit in the Y-axis direction with respect to the connection substrate 42 can be fixed with a simple configuration in which the lock holes 25c of the cage 25 fixed to the connection substrate 42 and the lock claws 32c of the elastic deformation parts 32 of the flexible substrate unit are engaged with each other.

The present disclosure is not limited to the above-described embodiments, and may be changed as appropriate without departing from the spirit of the present disclosure.

For example, the shape of the cage in the above-described embodiments is merely an example, it is sufficient that the flexible substrate unit can be inserted into and removed from the cage in the direction substantially perpendicular to the Z-axis direction and that the cage include the lock holes, and the method for fixing the cage to the connection substrate is not limited.

For example, the configuration of the flexible substrate unit according to the above-described embodiments is merely an example, and it is sufficient that the flexible substrate unit include lock claws that can engage with the lock holes of the cage when the flexible substrate unit is inserted into the cage.

For example, the shape of the pushing part according to the above-described embodiments is also merely an example, it is sufficient that the pushing part include such a configuration that the pushing part can push the housing unit toward the connection substrate when the flexible substrate unit is inserted into the cage, and the pushing part may be provided, for example, in one of the cage or the housing unit.

For example, while the cage includes the pinching parts 25d in the above-described embodiments, they may be omitted.

For example, while the lock claws are fixed to the housing in such a way that they are operable on the inner side of the housing and the outer side of the housing in the above-described embodiments, the configuration of the lock claws is not limited as long as the lock claws can be engaged with the lock holes.

The first, second and third embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A fixing structure of a flexible substrate and a connection substrate, the fixing structure comprising:
a housing that is fixed to the flexible substrate in such a way that contact points of the flexible substrate are exposed;
a lock claw fixed to the housing;
a cage that is fixed to the connection substrate so as to cover contact points of the connection substrate, the housing being capable of being inserted and removed into and from the cage in a direction parallel to a surface on which the contact points of the connection substrate are disposed;
a lock hole which is formed in the cage and with which the lock claw is engaged in a state in which the housing is inserted into the cage; and
a pushing part that is fixed to the housing or the cage and pushes the housing toward the connection substrate in the state in which the housing is inserted into the cage.

2. The fixing structure according to claim 1, wherein the cage includes a pinching part that pinches the housing from a direction that is perpendicular to the insertion and removal direction of the housing into and from the cage and a thickness direction of the housing.

3. The fixing structure according to claim 1, comprising an elastic deformation part comprising the lock claw that is fixed to the housing in such a way that the lock claw is operable on an inner side and an outer side of the housing and an operation part that operates the lock claw on the inner side of the housing, the elastic deformation part being fixed to the housing.

4. The fixing structure according to claim 3, wherein the housing comprises a protection unit that covers the elastic deformation part from a side opposite to a side of a direction in which the housing is removed from the cage and a side in which the contact points of the flexible substrate are exposed from the housing.

5. The fixing structure according to claim 3, comprising:
a shell that is fixed to the housing so as to cover a surface opposite to the surface of the housing on which the contact points of the flexible substrate are exposed, a pushing part that is fixed to the cage contacting the shell in the state in which the housing is inserted into the cage,
wherein, in the shell, the elastic deformation part that is disposed on each side of the housing is fixed in the direction that is perpendicular to the insertion and removal direction of the housing into and from the cage and a thickness direction of the housing.

6. The fixing structure according to claim 3, comprising:
a shell that is fixed to the housing so as to cover a surface opposite to the surface of the housing on which the contact points of the flexible substrate are exposed, the shell comprising the pushing part,
wherein, in the shell, the elastic deformation part that is disposed on each side of the housing is fixed in the direction that is perpendicular to the insertion and removal direction of the housing into and from the cage and a thickness direction of the housing.

7. The fixing structure according to claim 1, wherein the flexible substrate is insert-molded into the housing.

8. A substrate unit comprising:
the fixing structure according to claim 1;
a flexible substrate to which the housing of the fixing structure is fixed; and
a connection substrate to which the cage of the fixing structure is fixed, wherein
a plurality of rows of contact points of the connection substrate are disposed in such a way that they are spaced apart from each other in an insertion and removal direction of the housing into and from the cage, and
the contact points of the connection substrate are disposed in such a way that they do not overlap each other in a direction perpendicular to the insertion and removal direction of the housing into and from the cage and a thickness direction of the connection substrate as seen from the insertion and removal direction of the housing into and from the cage.

9. A flexible substrate unit used in the substrate unit according to claim 8, the flexible substrate unit comprising:
the flexible substrate;
a housing that is fixed to the flexible substrate in such a way that contact points of the flexible substrate are exposed, the housing being capable of being inserted and removed into and from the cage fixed to a connection substrate in a direction parallel to a surface on which contact points of the connection substrate are disposed;
a lock claw that is fixed in the housing and is capable of engaging with a lock hole formed in the cage; and
a contacting part that a pushing part that is fixed to the housing to push the housing toward the connection substrate in a state in which the housing is inserted into the cage or a pushing part that is fixed to the cage to push the housing toward the connection substrate in the state in which the housing is inserted into the cage contacts, the contacting part being fixed to the housing.
